(19) United States
(12) Patent Application Publication
(10) Pub. No.: US 2013/0309885 A1
(43) Pub. Date: Nov. 21, 2013

(54) HOLDER FOR SURFACE CONTACT CARD FOR ELECTRONIC DEVICE

(71) Applicants: SHENZHEN FUTAIHONG PRECISION INDUSTRY CO., LTD., (US); FIH (HONG KONG) LIMITED, Kowloon (HK)

(72) Inventors: ZHEN-LIN LIU, Shenzhen (CN); HUI-TAO QIU, Shenzhen (CN)

(73) Assignees: FIH (HONG KONG) LIMITED, Kowloon (HK); SHENZHEN FUTAIHONG PRECISION INDUSTRY CO., LTD., Shenzhen (CN)

(21) Appl. No.: 13/712,957

(22) Filed: Dec. 12, 2012

(30) Foreign Application Priority Data
May 17, 2012 (CN) 201210153345.1

(51) Int. Cl. H01R 13/629

(52) U.S. Cl. CPC H01R 13/629
USPC 439/153

(57) ABSTRACT

A holder for a surface contact card includes a housing, a tray for receiving the surface contact card, and an ejecting mechanism including a locking block and a first elastic member. The housing includes a base defining a receiving recess. The tray is slidably received in the receiving recess. The locking block releasably locks the tray in the receiving recess. The first elastic member flexibly resists the insertion of the tray into the housing. When the locking block is pushed by an outside force to release the locking by the locking block, the tray is ejected out of the receiving recess under the restoring force of the first elastic member.

### BACKGROUND

1. Technical Field

The present disclosure relates to surface contact card holders for electronic devices.

2. Description of Related Art

Portable electronic devices such as mobile phones include a holder for a surface contact card, such as a subscriber identity module (SIM) card.

Surface contact card holders include a tray assembled to the mobile phone. Although such surface contact card holders may be simple, it can be difficult for the card to be removed from the holder.

Therefore, there is room for improvement within the art.

### BRIEF DESCRIPTION OF THE DRAWINGS

Many aspects of the disclosure can be better understood with reference to the drawings. The components in the drawings are not necessarily drawn to scale, the emphasis instead being placed upon clearly illustrating the principles of the disclosure. Moreover, in the drawings, like reference numerals designate corresponding parts throughout the views.

FIG. 1 is an exploded, isometric view of a surface contact card holder in accordance with an exemplary embodiment.

FIG. 2 is an exploded, isometric view of the surface contact card holder of FIG. 1 viewed from another angle.

FIG. 3 is an enlarged view of a circled portion III of FIG. 2.

FIG. 4 is an assembled, isometric view of the surface contact card holder of FIG. 1.

FIG. 5 is a partially exploded, isometric view of the surface contact card holder of FIG. 1 in a first state.

FIG. 6 is a partially exploded, isometric view of the surface contact card holder of FIG. 1 in a second state.

### DETAILED DESCRIPTION

The surface contact card holder of the disclosure can effectively seat surface contact cards such as SIM cards, compact flash cards (CFs), multimedia cards (MMCs), and others. The electronic device of the disclosure, shown in the exemplary embodiment as a mobile phone, can alternatively be a personal digital assistant (PDA), camera, recorder, or other device remaining within the scope of the disclosure.

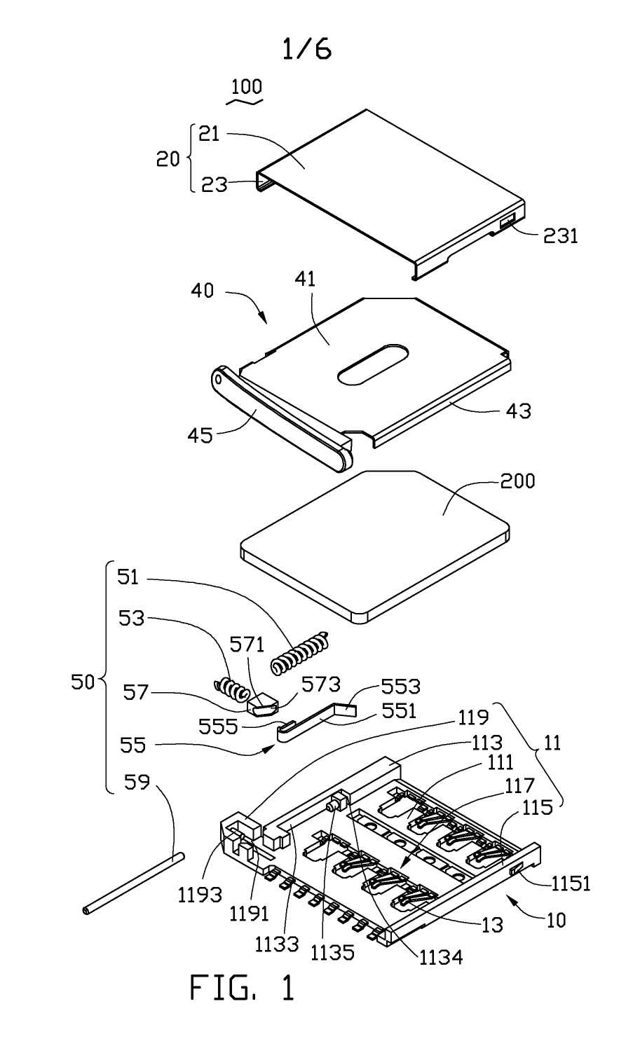

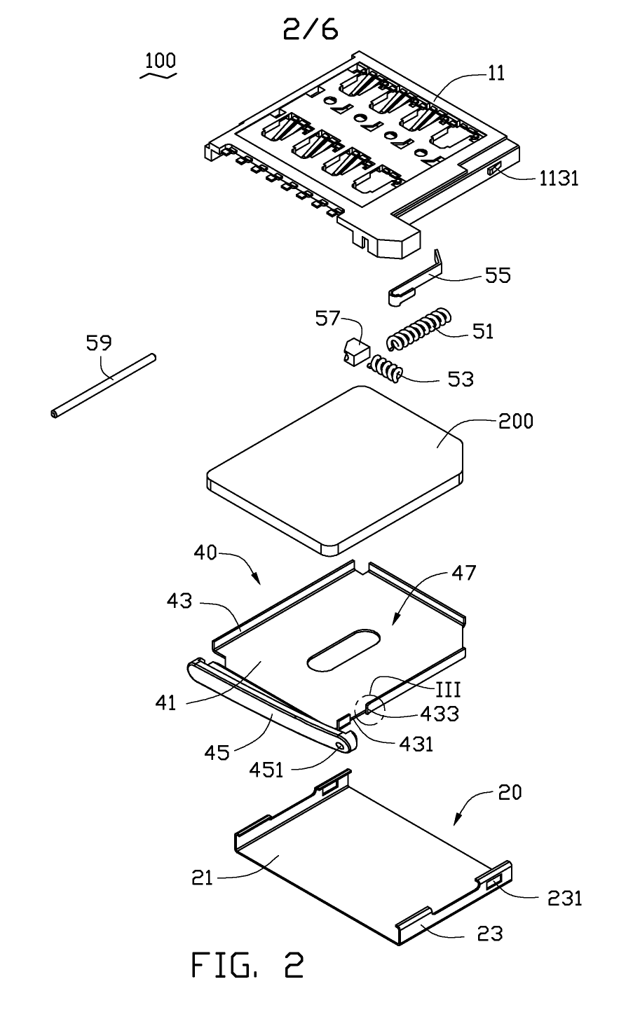

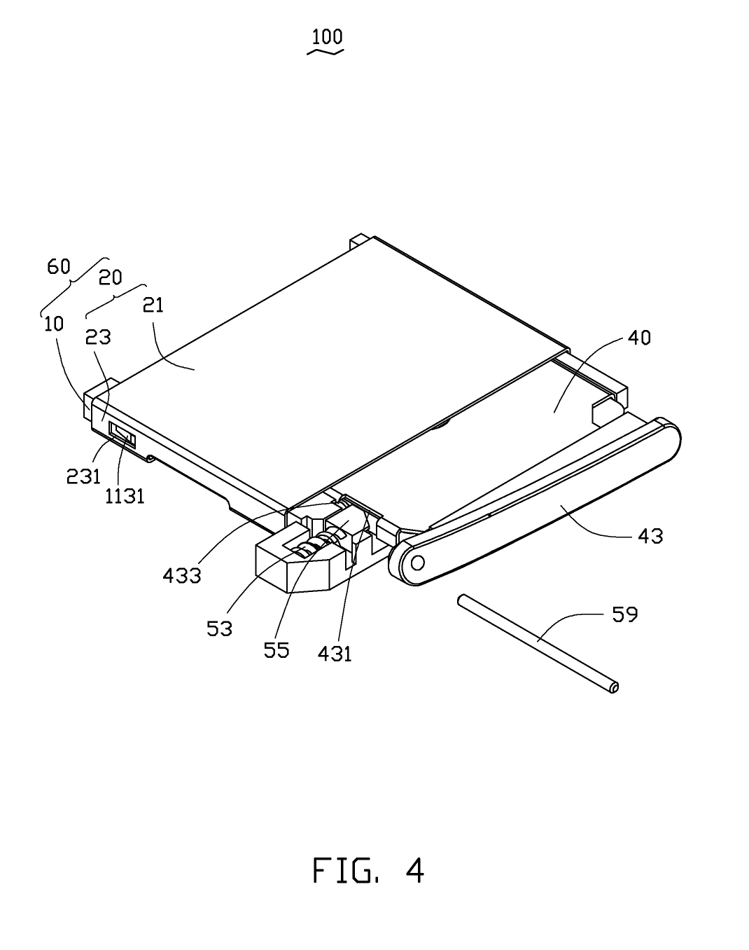

FIGS. 1 to 4 show an exemplary embodiment of a surface contact card holder 100 configured for receiving a surface contact card 200. The surface contact card holder 100 comprises a tray 40, an ejecting mechanism 50, and a housing 60 (shown in FIG. 4). The tray is slidably positioned in the housing 60. The housing 60 can be assembled in an electronic device. The housing 60 includes a main body 10 and a cover 20.

The main body 10 includes a base 11. The base 11 has a bottom wall 111, a first sidewall 113, a second sidewall 115, a receiving recess 117, and a protruding block 119. The first and second sidewalls 113, 115 perpendicularly extend from opposite ends of the bottom wall 111. The receiving recess 117 is surrounded by the bottom wall 111, the first sidewall 113, and the second sidewall 115. The protruding block 119 extends away from one edge of the bottom wall 111 adjacent to the first sidewall 113. The first side wall 113 has a first latching tab 1131, protruding from a side opposite to the receiving recess 117. The second sidewall 115 has a second latching tab 1151 protruding from a side opposite to the receiving recess 117. The first and second latching tabs 1131, 1151 are latched to the cover 20. The first sidewall 113 defines a mounting recess 1133 communicating with the receiving recess 117, thus forming two opposite mounting recess walls 1134. A first post 1135 extends from one mounting recess wall 1134 towards the other mounting recess wall 1134 and protrudes into the mounting recess 1133 to be parallel to the second side wall 115. The protruding block 119 defines a sliding recess 1191 communicating with the receiving recess 117 and has a second post 1193 protruding into the sliding recess 1191 and extending towards the receiving recess 117.

The main body 10 may further include a plurality of electrical contacts 13 for electronically connecting to the card 200. The plurality of electrical contacts 13 are separately positioned on the bottom wall 111.

The cover 20 includes a top wall 21 and two sidewalls 23 extending perpendicularly from opposite ends of the top wall 21. Each of the sidewalls 23 defines a latching hole 231. The cover 20 covers the base 11, with the top wall 21 covering the receiving recess 117, a sidewall 23 abutting against each of the first and second sidewalls 113, 115, and each of the first and second latching tabs 1131, 1151 latched in one of the latching holes 231 (as shown in FIG. 4).

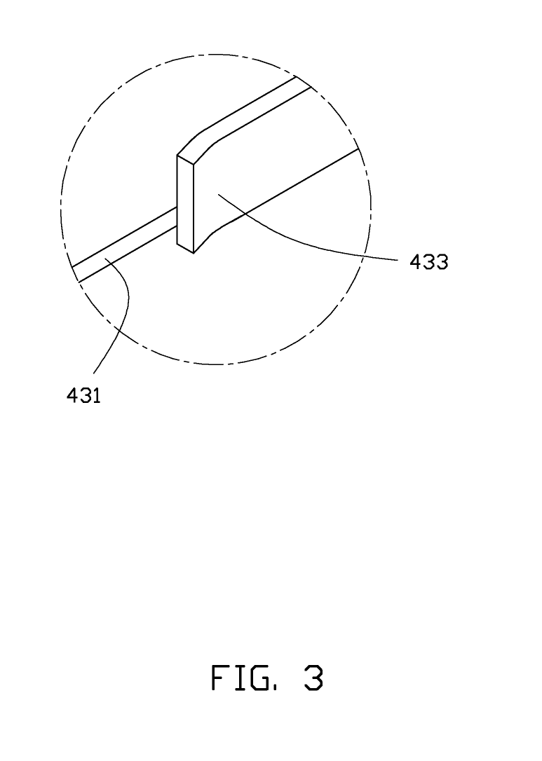

The tray 40 supports the card 200 and brings the card 200 into or out of the receiving recess 117. The tray 40 includes a bottom plate 41, a number of side edges 43, and a handle portion 45. The side edges 43 and the handle portion 45 each extend perpendicularly from an edge of the bottom plate 41. The bottom plate 41, the side edges 43, and the handle portion 45 cooperatively define an accommodating space 47 for accommodating the surface contact card 200. One of the side edges 43 adjacent to the handle portion 45 has an opening 431 and a warped portion 433. The warped portion 433 is defined by an end portion of the side edge 43, adjacent to the opening 431, bent away from the accommodating space 47 (shown in FIG. 3). The handle portion 45 defines a hole 451.

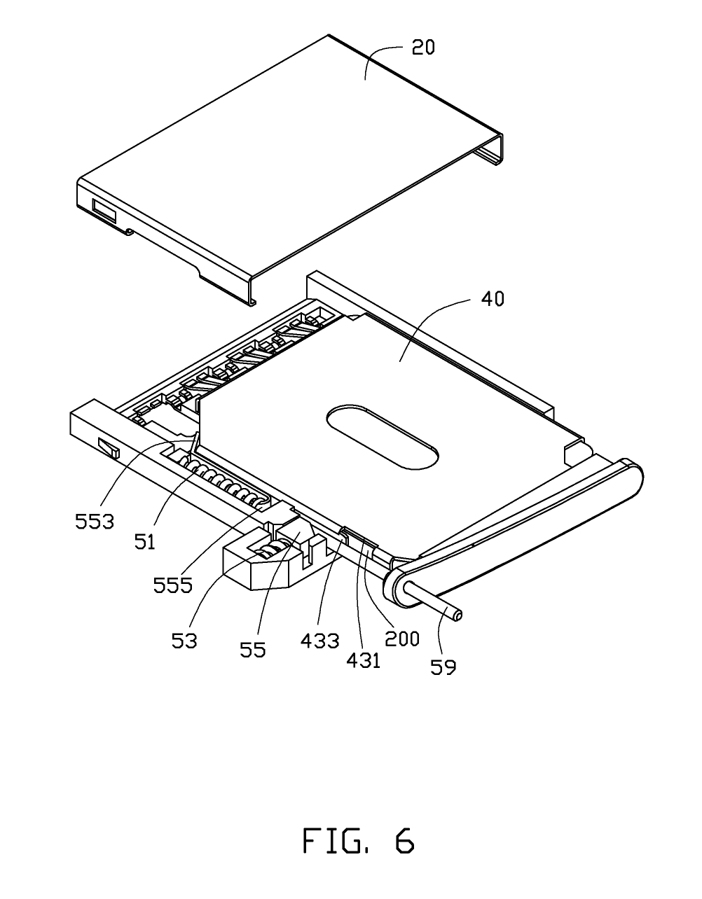

Referring to FIGS. 1, 5, and 6, the ejecting mechanism 50 includes a first elastic member 51, a second elastic member 53, a transmission member 55, a locking block 57, and a pin 59. In one embodiment, the first and second elastic members 51, 53 are each a compression spring. Alternatively, the first and second elastic members 51, 53 can be other compressive members, such as rubber. The first elastic member 51 is received in the mounting recess 1133, with a first end coiled around the first post 1135. The second elastic member 53 is received in the sliding recess 1191, with a first end coiled around the second post 1193. The first elastic member 51 has an extension direction perpendicular to that of the second elastic member 53.

The first elastic member 51 provides elastic force to push the tray 40 out of the receiving recess 117. In this exemplary embodiment, the first elastic member 51 uses the transmission member 55 to elastically resist the tray 40. A first end of the transmission member 55 abuts against the tray 40, and a second end of the transmission member 55 is attached to a second end of the first elastic member 51. When the tray 40 is locked in the receiving recess 117, the tray 40 pushes against the transmission member 55 to compress the first elastic member 51, and the first elastic member 51 accumulates restoring force. The restoring force of the first elastic member 51 acting through the transmission member 55 can also push the tray 40 with the card 200 out of the receiving recess 117.

The transmission member 55 includes a connecting portion 551, an abutting portion 553, and a clasp portion 555. The abutting portion 553 extends from a first end of the connecting portion 551 and bends towards a first side of the connecting portion 551. The clasp portion 555 extends from a second end of the connecting portion 551 opposite to the first end and bends towards a second side, of the connecting portion 551 that is opposite to the first side, to be substantially parallel to the connecting portion 551. The connecting portion 551, the abutting portion 553, and the clasp portion 555 are all a flat strip of material. The abutting portion 553 abuts against the tray 40 at a substantially end portion opposite to the handle portion 45. The clasp portion 555 extends into a second end of the first elastic member 51, thereby latching with the first elastic member 51.

The locking block 57 may be wedge-shaped, and includes an inclined surface 571. The locking block 57 is slidably received in the sliding recess 1191. A first end of the locking block 57 is elastically resisted by the second elastic member 53. The inclined surface 571 is adjacent to a second end, and the second end of the locking block 57 is releasably locked in the opening 431 of the tray 40, to resist the ejection of the card 200. When the locking block 57 is inserted through the opening 431 and resists the card 200 and the warped portion 433, the tray 40 is stopped from being pushed out of receiving recess 117 by the accumulated restoring force of the first elastic member 51, thus keeping the tray 40 with the card 200 in the receiving recess 117. The locking block 57 defines a guiding recess 573 in the inclined surface 571. The guiding recess 573 extends at an inclined angle to the tray 40. Finger pressure against the pin 59 moves it through the hole 451 of the handle portion 45, to abut against the locking block 57 in the guiding recess 573, thus forcing the locking block 57 to compress the second elastic member 53 until the locking block 57 is withdrawn from the opening 431. Thus, the locking of the tray 40 by the locking block 57 is released. In this case, the tray 40 with the card 200 is ejected out of the receiving recess 117 under the accumulated restoring force of the first elastic member 51. In the exemplary embodiment, the pin 59 is a cylinder.

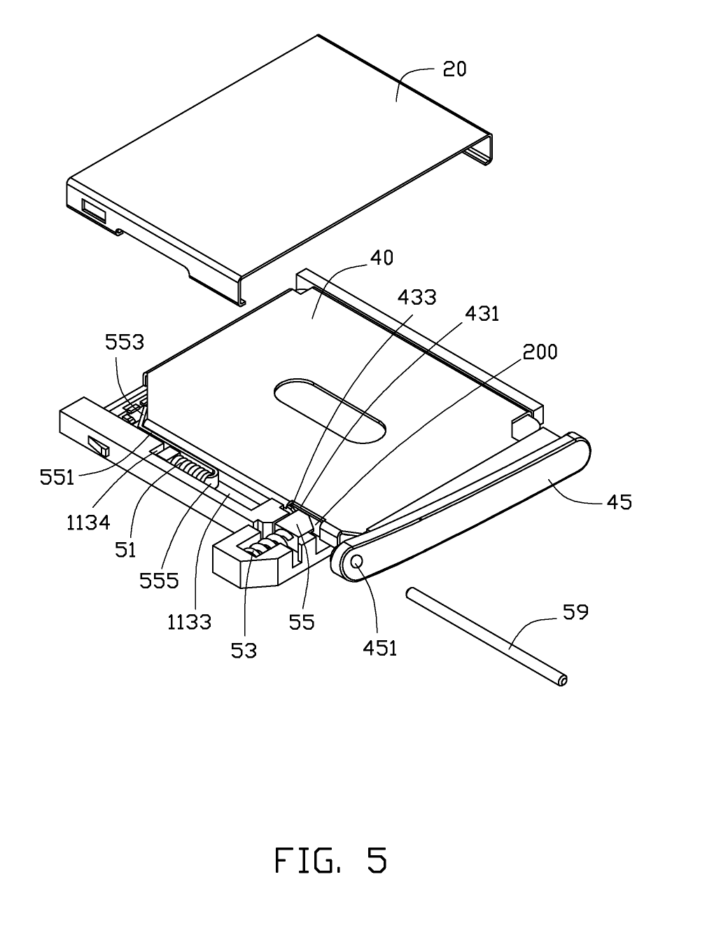

Referring to FIG. 4 and FIG. 5, to assemble the surface contact card holder 100, the first elastic member 51 is positioned within the mounting recess 1133 and the first end of the first elastic member 51 is coiled around the first post 1135. The clasp portion 555 of the transmission member 55 is inserted into the second end of the first elastic member 51. The second elastic member 53 is positioned within the sliding recess 1191 and a first end of the second elastic member 53 is coiled around the second post 1193. Then, the locking block 57 is positioned within the sliding recess 1191 to resist a second end of the second elastic member 53. Subsequently, the main body 10 is inserted into the cover 20, with the first and second latching tabs 1131, 1151 latched in the latching holes 231. The tray 40 is inserted into the receiving recess 117. The tray 40 pushes the abutting portion 553 of the transmission member 55 to compress the first elastic member 51. The locking block 57 extends into the opening 431 of the tray 40.

To mount the card 200 into the holder 100 or to change the card 200, the pin 59 is inserted through the hole 451 of the handle portion 45 to resist the locking block 57 in the guiding recess 573. The second elastic member 53 is compressed by the locking block 57, until the locking block 57 is withdrawn from the opening 431, to unlock the tray 40. In this case, the accumulated restoring force of the first elastic member 51 is released against the transmission member 55, thus making the abutting portion 553 move, to enable the tray 40 to be ejected out of the receiving recess 117 under the force of the first elastic member 51. A card 200 can be inserted into the accommodating space 47 of the tray 40 or can be removed. To close the holder 100, the pin 59 is taken out of the hole 451. Then, the handle portion 45 is pushed towards the receiving recess 117, until the locking block 57 slides into the opening 431 and resists the warped portion 433. Thus, the tray 40 with the card 200 is again locked within the receiving recess 117.

The pin 59 can be omitted in favor of some other acicular object such as a toothpick.

It is to be understood, however, that even through numerous characteristics and advantages of the present disclosure have been set forth in the foregoing description, together with details of assembly and function, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A surface contact card holder, comprising:
a housing, the housing comprises a base defining a receiving recess;
a tray, for receiving a surface contact card, slidably received in the receiving recess; and
an ejecting mechanism comprising a locking block and a first elastic member, the locking block releasably locking the tray to releasably keep the tray in the receiving recess, and the first elastic member elastically resisting the tray;
wherein when the locking block is pushed by an outside force to release the locking of the tray by the locking block, the tray is ejected out of the receiving recess under the force of the first elastic member.

2. The holder as claimed in claim 1, wherein the locking block has an inclined surface that is adjacent to an end facing the tray; and the ejecting mechanism further comprises a pin configured for resisting and pushing the inclined surface of the locking block to unlock the tray.

3. The holder as claimed in claim 2, wherein the tray comprises a bottom plate, a number of side edges, and a handle portion; the side edges and the handle portion each extend perpendicularly from an edge of the bottom plate; and the bottom plate, the side edges, and the handle portion cooperatively define an accommodating space for accommodating the surface contact card.

4. The holder as claimed in claim 3, wherein one of the side edges adjacent to the handle portion defines an opening; and the locking block is releasably locked in the opening.

5. The holder as claimed in claim 4, wherein the side edge that defining the opening further comprises a warped portion, the warped portion is defined by an end portion of the side edge, adjacent to the opening, bent away from the accommodating space; and when the locking block is locked in the opening, the locking block is resisted by the warped portion.

6. The holder as claimed in claim 4, wherein the handle portion defines a hole for inserting the pin therethrough to abut against and push the locking block, forcing the locking block to withdraw from the opening.

7. The holder as claimed in claim 6, wherein the locking block defines a guiding recess in the inclined surface; when the pin is inserted through the hole to unlock the tray, the pin resists the locking block in the guiding recess.

8. The holder as claimed in claim 1, wherein the base comprises a bottom wall, a first sidewall, and a second sidewall; the first and second sidewalls perpendicularly extend from opposite ends of the bottom wall; the bottom wall, the first sidewall, and the second sidewall cooperatively surround the receiving recess; the first sidewall defines a mounting recess communicating with the receiving recess; and the first elastic member is received in the mounting recess.

9. The holder as claimed in claim 8, wherein the ejecting mechanism further comprises a transmission member; a transmission member first end abuts against the tray, and a transmission member second end is attached to the first elastic member; when the tray is locked in the receiving recess, the tray pushes the transmission member to compress the first elastic member, enabling the first elastic member to accumulate restoring force; when the locking of the tray by the locking block is released, the restoring force drives the tray out of the receiving recess.

10. The holder as claimed in claim 9, wherein the transmission member includes a connecting portion, an abutting portion extending from a connecting portion first end, and a clasp portion extending from a connecting portion second end; the abutting portion and the clasp portion bend towards opposite sides of the connecting portion; the abutting portion abuts against the tray; and the clasp portion extends into an end of the first elastic member to latch with the first elastic member.

11. The holder as claimed in claim 8, wherein the base further includes a protruding block extending away from one edge of the bottom wall adjacent to the first sidewall; the protruding block defines a sliding recess communicating with the receiving recess; the ejecting mechanism further comprises a second elastic member received in the sliding recess; the locking block is slidably received in the sliding recess and is elastically resisted by the second elastic member; and the locking block is able to be driven by the second elastic member to move towards the tray to be locked with the tray.

12. The holder as claimed in claim 8, the housing further comprises a cover, the cover includes a top wall and two sidewalls extend perpendicularly from opposite ends of the top wall; each of the sidewalls of the cover defines a latching hole; each of the first and second sidewalls of the base has a latching tab; the cover covers the base, with the top wall covering the receiving recess, each of the sidewalls of the cover abutting against one of the first and second sidewalls of the base, and each of the latching tabs latched in one of the latching holes.

13. An electronic device comprising a surface contact card holder, the surface contact card holder mounted on the electronic device and comprising:
a housing, the housing comprises a base defining a receiving recess;
a tray, for receiving a surface contact card, slidably received in the receiving recess; and
an ejecting mechanism comprising a locking block and a first elastic member, the locking block releasably locking the tray to releasably keep the tray in the receiving recess, and the first elastic member elastically resisting the tray;
wherein when the locking block is pushed by an outside force to release the locking of the tray by the locking block, the tray is ejected out of the receiving recess under the force of the first elastic member.

14. The electronic device as claimed in claim 13, wherein the locking block has an inclined surface that is adjacent to an end facing the tray; and the ejecting mechanism further comprises a pin configured for resisting and pushing the inclined surface of the locking block to unlock the tray.

15. The electronic device as claimed in claim 14, wherein the tray includes a bottom plate, a number of side edges, and a handle portion; the side edges and the handle portion each extends perpendicularly from an edge of the bottom plate; the bottom plate, the side edges, and the handle portion cooperatively define an accommodating space for accommodating the surface contact card; one of the side edges adjacent to the handle portion defines an opening; and the locking block is releasably locked in the opening.

16. The electronic device as claimed in claim 15, wherein the handle portion defines a hole for inserting the pin therethrough to abut against and push the locking block, forcing the locking block to withdraw from the opening.

17. The electronic device as claimed in claim 13, wherein the base includes a bottom wall, a first sidewall, and a second sidewall; the first and second sidewalls perpendicularly extend from opposite ends of the bottom wall; the bottom wall, the first sidewall, and the second sidewall cooperatively surround the receiving recess; the first sidewall defines mounting recess communicating with the receiving recess; and the first elastic member is received in the mounting recess.

18. The electronic device as claimed in claim 17, wherein the ejecting mechanism further comprises a transmission member; a transmission member first end abuts against the tray, and a transmission member second end is attached to the first elastic member;
when the tray is locked in the receiving recess, the tray pushes the transmission member to compress the first elastic member, enabling the first elastic member to accumulate restoring force; when the locking of the tray by the locking block is released, the restoring force drives the tray out of the receiving recess.

19. The electronic device as claimed in claim 18, wherein the transmission member includes a connecting portion, an abutting portion extending from a connecting portion first end, and a clasp portion extending from a connecting portion second end; the abutting portion and the clasp portion bend towards opposite sides of the connecting portion; the abutting portion abuts against the tray; and the clasp portion extends into an end of the first elastic member to latch with the first elastic member.

20. The electronic device as claimed in claim 17, wherein the base further includes a protruding block extending away from one edge of the bottom wall adjacent to the first sidewall; the protruding block defines a sliding recess communicating with the receiving recess; the ejecting mechanism further comprises a second elastic member received in the sliding recess; the locking block is slidably received in the sliding recess and is elastically resisted by the second elastic member; the locking block is able to be driven by the second elastic member to move towards the tray to be locked with the tray.
